(19) United States
(12) Patent Application Publication
(10) Pub. No.: US 2024/0336768 A1
(43) Pub. Date: Oct. 10, 2024

(54) BLENDS OF POST CONUMER RESINS AND POLYETHYLENE FOR QUALITY BLOWN FILM

(71) Applicant: Equistar Chemicals, LP, Houston, TX (US)

(72) Inventor: Jeffrey J. Strebel, Cincinnati, OH (US)

(73) Assignee: Equistar Chemicals, LP, Houston, TX (US)

(21) Appl. No.: 18/627,073

(22) Filed: Apr. 4, 2024

Related U.S. Application Data
(60) Provisional application No. 63/457,282, filed on Apr. 5, 2023.

(51) Int. Cl. C08L 23/06; C08J 5/18

(52) U.S. Cl. CPC C08L 23/06; C08J 5/18; C08J 2323/06; C08L 2203/16; C08L 2205/025; C08L 2207/066; C08L 2207/20

(57) ABSTRACT

Blends of post-consumer recycled (PCR) polymer waste and polyethylene, and methods for manufacturing and using the same are provided. In at least one implementation, the blend includes a virgin linear low-density polyethylene (LLDPE) resin present in an amount ranging from about 25 wt. % to about 99 wt. % based on a total weight of the composition and a post-consumer recycled polyethylene (PCR-PE) resin present in an amount ranging from about 1 wt. % to about 75 wt. % based on a total weight of the composition. The blends may be used to produce products in the form of sheets, films, pipes, strands, tubes, containers, or pellets.

### PRIOR RELATED APPLICATIONS

This application claims the benefit of priority to U.S. Provisional Application No. 63/457,282, filed on Apr. 5, 2023, which is incorporated herein by reference in its entirety.

### TECHNICAL FIELD

Aspects of the present disclosure generally relate to post-consumer recycled (PCR) polymer waste. More particularly, the disclosure relates to blends of PCR and polyethylene, and methods for manufacturing and using the same.

### BACKGROUND

Heightened standards of living and increased urbanization have led to an increased demand for polymer products, particularly polyolefin plastics. Polyolefins have been frequently used in commercial plastics applications because of their outstanding performance and cost characteristics. Polyethylene (PE), for example, has become one of the most widely used and recognized polyolefins because PE is strong, extremely tough, and very durable. This allows PE to be highly engineered for a variety of applications. Similarly, polypropylene (PP) is mechanically rugged yet flexible, is heat resistant, and is resistant to many chemical solvents like bases and acids. Thus, it is ideal for various end-use industries, mainly for packaging and labeling, textiles, plastic parts, and reusable containers of various types.

The downside to the demand for polyolefin plastics is the increase in waste. Post-consumer plastic waste typically ends up in landfills, with about 12% being incinerated and about 9% being diverted to recycling. In landfills, most plastics do not degrade quickly, becoming a major source of waste that overburdens the landfill. Incineration is also not an ideal solution to treating the plastic wastes as incineration leads to the formation of carbon dioxide and other greenhouse gas emissions. As such, there has been much interest in developing methods of recycling plastic waste to reduce the burden on landfills while being environmentally friendly.

One drawback to the recycling of plastic wastes is the difficulty in successfully producing commercially usable or desirable products. Plastic waste recycling currently includes washing the material and mechanically reprocessing. As post-consumer plastic waste has often been exposed to repeated heating cycles or UV light before being recycled, reprocessed materials have a reduction in mechanical properties compared to the virgin materials. While recycled materials are easily used for items like plastic bags and disposable packaging, the pellets may be undesirable for most uses requiring safety, strength, or performance.

Thus, there exists a continued need for the development of compositions that utilize recycled post-consumer polyolefin waste for the production of commercially usable products.

### SUMMARY

In at least one aspect, a composition is provided. The composition includes a virgin linear low-density polyethylene (LLDPE) resin present in an amount ranging from about 25 wt. % to about 99 wt. % based on a total weight of the composition and a post-consumer recycled polyethylene (PCR-PE) resin present in an amount ranging from about 1 wt. % to about 75 wt. % based on a total weight of the composition.

Implementations can include one or more of the following. The virgin LLDPE has a density ranging from 0.910 to 0.922 g/cm³. The virgin LLDPE is a hexene-based LLDPE. The virgin LLDPE resin has a melt flow ratio greater than or equal to 0.6 g/10 min (190° C./2.16 kg). The virgin LLDPE resin has a dart drop impact strength, F50 (ASTM D1709) in a range from about 600 g to about 700 g and a tensile strength at break, MD (ASTM D882) in a range from about 60 MPa to about 70 MPa. The virgin LLDPE has a melt flow ratio greater than or equal to 1.0 g/10 min (190° C./2.16 kg). The virgin LLDPE has a dart drop impact strength, F50 (ASTM D1709) in a range from about 150 g to about 200 g and a tensile strength at break, MD (ASTM D882) in a range from about 50 MPa to about 60 MPa. The PCR-PE resin is present in an amount ranging from about 10 wt. % to about 50 wt. % based on a total weight of the composition and the virgin LLDPE resin is present in an amount ranging from about 50 wt. % to about 90 wt. % based on a total weight of the composition. The PCR-PE resin is present in an amount ranging from about 20 wt. % to about 30 wt. % based on a total weight of the composition. The virgin LLDPE resin is present in an amount ranging from about 70 wt. % to about 80 wt. % based on a total weight of the composition.

In at least another aspect, a film structure is provided. The film structure including (A) an A Layer, comprising linear low-density polyethylene (LLDPE) or high-density polyethylene (HDPE). The film structure further includes (B) a B Layer, comprising a virgin linear low-density polyethylene (virgin LLDPE) and a post-consumer recycled polyethylene (PCR-PE) resin present in an amount ranging from about 1 wt. % to about 75 wt. % based on a total weight of the virgin LLDPE and the PCR-PE, and the virgin LLDPE resin is present in an amount ranging from about 25 wt. % to about 99 wt. % based on a total weight of the virgin LLDPE and the PCR-PE. The film structure further includes (C) a C Layer, comprising LLDPE or HDPE, wherein the B Layer is positioned between the A Layer and the C Layer.

Implementations can include one or more of the following: The virgin LLDPE has a density ranging from 0.910 to 0.922 g/cm³. The virgin LLDPE is a hexene-based LLDPE. The virgin LLDPE resin has a melt flow ratio greater than or equal to 0.6 g/10 min (190° C./2.16 kg). The virgin LLDPE resin has a dart drop impact strength, F50 (ASTM D1709) in a range from about 600 g to about 700 g and a tensile strength at break, MD (ASTM D882) in a range from about 60 MPa to about 70 MPa. The virgin LLDPE has a melt flow ratio greater than or equal to 1.0 g/10 min (190° C./2.16 kg). The virgin LLDPE has a dart drop impact strength, F50 (ASTM D1709) in a range from about 150 g to about 200 g and a tensile strength at break, MD (ASTM D882) in a range from about 50 MPa to about 60 MPa. The PCR-PE resin is present in an amount ranging from about 10 wt. % to about 50 wt. % based on a total weight of the composition and the virgin LLDPE resin is present in an amount ranging from about 50 wt. % to about 90 wt. % based on a total weight of the composition. The PCR-PE resin is present in an amount ranging from about 20 wt. % to about 30 wt. % based on a total weight of the composition. The virgin LLDPE resin is present in an amount ranging from about 70 wt. % to about 80 wt. % based on a total weight of the composition. An article formed from the composition of a virgin linear low-density polyethylene (virgin LLDPE) resin present in an amount ranging from about 25 wt. % to about 99 wt. % based on a total weight of the composition and a post-consumer recycled polyethylene (PCR-PE) resin present in an amount ranging from about 1 wt. % to about 75 wt. % based on a total weight of the composition. The article is in the form of sheets, films, pipes, strands, tubes, containers, or pellets. The article is a blown film.

In at least another aspect, an article is provided. The article is formed from a composition of a virgin linear low-density polyethylene (virgin LLDPE) resin present in an amount ranging from about 25 wt. % to about 99 wt. % based on a total weight of the composition and a post-consumer recycled polyethylene (PCR-PE) resin present in an amount ranging from about 1 wt. % to about 75 wt. % based on a total weight of the composition.

Implementations may include one or more of the following. The article is in the form of sheets, films, pipes, strands, tubes, containers, or pellets. The article is a blown film. The virgin LLDPE has a density ranging from 0.910 to 0.922 g/cm³. The virgin LLDPE is a hexene-based LLDPE. The virgin LLDPE resin has a melt flow ratio greater than or equal to 0.6 g/10 min (190° C./2.16 kg). The virgin LLDPE resin has a dart drop impact strength, F50 (ASTM D1709) in a range from about 600 g to about 700 g and a tensile strength at break, MD (ASTM D882) in a range from about 60 MPa to about 70 MPa. The virgin LLDPE has a melt flow ratio greater than or equal to 1.0 g/10 min (190° C./2.16 kg). The virgin LLDPE has a dart drop impact strength, F50 (ASTM D1709) in a range from about 150 g to about 200 g and a tensile strength at break, MD (ASTM D882) in a range from about 50 MPa to about 60 MPa. The PCR-PE resin is present in an amount ranging from about 10 wt. % to about 50 wt. % based on a total weight of the composition and the virgin LLDPE resin is present in an amount ranging from about 50 wt. % to about 90 wt. % based on a total weight of the composition. The PCR-PE resin is present in an amount ranging from about 20 wt. % to about 30 wt. % based on a total weight of the composition. The virgin LLDPE resin is present in an amount ranging from about 70 wt. % to about 80 wt. % based on a total weight of the composition.

### BRIEF DESCRIPTION OF THE DRAWINGS

So that the manner in which the above-recited features of the present disclosure can be understood in detail, a more particular description of the aspects, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a schematic illustration of a multi-layer film structure according to at least one aspect of the present disclosure.

FIG. 2 is a bar graph illustrating the results of a tensile modulus test performed for the compositions presented in the examples section of the present application.

FIG. 3 is a bar graph illustrating the results of a tear strength test performed for the compositions presented in the examples section of the present application.

FIG. 4 is a bar graph illustrating the results of a dart drop test performed for the compositions presented in the examples section of the present application.

FIG. 5 is a bar graph illustrating the results of a total energy dart drop test performed for the compositions presented in the examples section of the present application.

FIG. 6 is a bar graph illustrating the results of a tensile strength test performed for the compositions presented in the examples section of the present application.

FIG. 7 is a bar graph illustrating the results of a gloss test performed for the multi-layer film structures presented in the examples section of the present application.

FIG. 8 is a bar graph illustrating the results of a haze test performed for the multi-layer film structures presented in the examples section of the present application.

FIG. 9 is a bar graph illustrating the results of a narrow angle scattering test performed for the multi-layer film structures presented in the examples section of the present application.

FIG. 10 is a bar graph illustrating the results of a tear strength test performed for the multi-layer film structures presented in the examples section of the present application.

FIG. 11 is a bar graph illustrating the results of a break strength test performed for the multi-layer film structures presented in the examples section of the present application.

FIG. 12 is a bar graph illustrating the results of a puncture test performed for the multi-layer film structures presented in the examples section of the present application.

FIG. 13 is a bar graph illustrating the results of a total energy dart drop test performed for the multi-layer film structures presented in the examples section of the present application.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

Illustrative aspects of the subject matter claimed will now be disclosed. In the interest of clarity, not all features of an actual implementation are described in this specification. It will be appreciated that in the development of any such actual aspect, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present disclosure provides novel compositions utilizing post-consumer recycled (PCR) polyolefin waste. In particular, the PCR polyolefin is combined with virgin material to form a blend.

In nearly all areas of plastics packaging, efforts are underway to use recycled materials. However, many of the physical and mechanical properties of PCR materials are lower than that for virgin resins because the polymer chains in the PCR have been broken from repeated heating, shearing of the polyolefin in the extruder, or exposure to UV. Thus, incorporation of PCR usually results in an inferior product when compared to virgin resins.

Despite these challenges, a quality blown film with 30% PCR content is described. The quality blown film is suitable for use in trash bags, drop cloths, and other similar applications. The quality blown film is produced from a blend of PCR with linear low-density polyethylene (LLDPE), for example, superhex LLDPE or Petrothene R GA601 (available from LyondellBasell).

### A. PCR-Polyethylene Composition

In more detail, the PCR-PE compositions described herein include: (1) at least one virgin linear low-density polyethylene (LLDPE); and (2) at least one PCR polyethylene. The compositions may be extruded into articles or blown into films with physical properties (durability, flexural strength, flexural modulus, and impact resistance) that are acceptable for various applications including as heavy duty shipping sacks, prime liners, bags, sheets, fibers, commercial and industrial packaging, food and consumer packaging, and films.

### Virgin LLDPE

The compositions disclosed herein include at least one virgin LLDPE. In at least one aspect, the virgin LLDPE includes ethylene derived units copolymerized with a comonomer selected from the group consisting of 1-butene, 1-hexene, 1-octene, or a combination thereof. The virgin LLDPE may include a metallocene-derived LLDPE, a Ziegler-Natta-derived LLDPE, and/or any LLDPE derived from any other catalyst known in the art. In another aspect, the comonomer is present in an amount ranging from 4 to 30 wt. %, based upon the total weight of the LLDPE.

In at least one aspect, the virgin LLDPE is a LLDPE with a hexene comonomer, for example, a hexene-based LLDPE. In one example, the virgin LLDPE is a hexene-based LLDPE having a melt index of about 0.6 g/10 min and a density of 0.9165 g/cm³. In another example, the virgin LLDPE is a hexene-based, LLDPE having a melt index of about 0.9 g/10 min and a density of 0.9165 g/cm³. In yet another example, the virgin LLDPE is a hexene-based LLDPE having a melt index of about 1.0 g/10 min, and a density of 0.918 g/cc.

In at least one aspect, the total amount of virgin LLDPE in the present composition is in a range from about 25 wt. % to about 99 wt. % based on the total weight of the composition. In some implementations, the total amount of virgin LLDPE present is in a range from about 25 wt. % to about 90 wt. %, or in a range from about 30 wt. % to about 90 wt. %, or in a range from about 35 wt. % to about 90 wt. %, or in a range from about 40 wt. % to about 90 wt. %, or in a range from about 45 wt. % to about 90 wt. %, or in a range from about 50 wt. % to about 90 wt. %, or in a range from about 55 wt. % to about 90 wt. %, or in range from about 60 wt. % to about 90 wt. %, or in a range from about 65 wt. % to about 90 wt. %, or in a range from about 70 wt. % to about 90 wt. %, or in a range from about 70 wt. % to about 80 wt. %, or in a range from about 65 wt. % to about 75 wt. %, or in a range from about 70 wt. % to about 75 wt. %, or the total amount of virgin LLDPE present is in an amount of 25, 30, 35, 40, 45, 50, 55, 60, 65, 70, 75, 80, 85, 90, 95, or 99 wt. %.

In at least one aspect, the virgin LLDPE has a melt index ranging from 0.4 to 1.0 g/10 min. In another aspect, the virgin LLDPE has a melt index ranging from 0.6 to 1.0 g/10 min. In yet another aspect, the virgin LLDPE has a melt index ranging from 0.6 to 0.7 g/10 min. In yet another aspect, the virgin LLDPE has a melt index of 0.6 g/10 min. In each of the foregoing aspects, the melt index is measured according to ASTM D1238.

In at least one aspect, the virgin LLDPE has a density ranging from 0.910 to 0.922 g/cm³. In another aspect, the virgin LLDPE has a density ranging from 0.916 to 0.922 g/cm³. In yet another aspect, the virgin LLDPE has a density of 0.916, 0.917, 0.918, 0.919, 0.920, 0.921 or 0.922 g/cm³. The foregoing densities are measured according to ASTM D1505.

In at least one aspect, the virgin LLDPE has a polydispersity index ranging from 2.0 to 16.0, as measured by ASTM D6474-12. In another aspect, the virgin LLDPE has a polydispersity index ranging from 5.0 to 16.0. In each of the foregoing aspects, the polydispersity index is measured according to ASTM D6474-12.

In at least one aspect, the virgin LLDPE has a MFR greater than or equal to 0.1 g/10 min (190° C./2.16 kg), or greater than or equal to 0.2 g/10 min (190° C./2.16 kg), or greater than or equal to 0.3 g/10 min (190° C./2.16 kg), or greater than or equal to 0.5 g/10 min (190° C./2.16 kg), or greater than or equal to 0.6 g/10 min (190° C./2.16 kg). In at least one aspect, the virgin LLDPE has a MFR in a range from about 0.5 g/10 min (190° C./2.16 kg) to about 0.7 g/10 min, alternately in a range from about 0.5 g/10 min (190° C./2.16 kg) to about 0.6 g/10 min (190° C./2.16 kg). In at least one aspect, the virgin LLDPE has at least one of: a dart drop impact strength, F50 (ASTM D1709) in a range from about 600 g to about 700 g, alternatively about 650 g, a tensile strength at break, MD (ASTM D882) in a range from about 60 MPa to about 70 MPa, alternatively about 65 MPa, a tensile strength at break, TD (ASTM D882) in a range from about 40 MPa to about 50 MPa, alternatively about 48 MPa, a tensile elongation at break, MD (ASTM D882) in a range from about 450% to about 550%, alternatively about 500%, a tensile elongation at break, TD (ASTM D882) in a range from about 650% to about 750%, alternatively about 700%, a 1% secant modulus, MD (ASTM D882) in a range from about 180 MPa to about 200 MPa, alternatively about 186 MPa, a 1% secant modulus, TD (ASTM D882) in a range from about 190 MPa to about 210 MPa, alternatively about 200 MPa, an Elmendorf Tear Strength, MD (ASTM D1922) in a range from about 400 g to about 500 g, alternatively about 450 g, and an Elmendorf Tear Strength, TD (ASTM D1922) in a range from about 600 g to about 700 g, alternatively about 650 g.

In at least one aspect, the virgin LLDPE has a MFR greater than or equal to 0.7 g/10 min (190° C./2.16 kg), or greater than or equal to 0.8 g/10 min (190° C./2.16 kg), or greater than or equal to 0.9 g/10 min (190° C./2.16 kg), or greater than or equal to 0.918 g/10 min (190°° C./2.16 kg), or greater than or equal to 0.922 g/10 min (190° C./2.16 kg). In at least one aspect, the virgin LLDPE has at least one of: a dart drop impact strength, F50 (ASTM D1709) in a range from about 150 g to about 200 g, alternatively about 190 g, a tensile strength at break, MD (ASTM D882) in a range from about 50 MPa to about 60 MPa, alternatively about 56 MPa, a tensile strength at break, TD (ASTM D882) in a range from about 40 MPa to about 50 MPa, alternatively about 42 MPa, a tensile elongation at break, MD (ASTM D882) in a range from about 500% to about 600%, alternatively about 580%, a tensile elongation at break, TD (ASTM D882) in a range from about 650% to about 750%, alternatively about 700%, a 1% secant modulus, MD (ASTM D882) in a range from about 190 MPa to about 210 MPa, alternatively about 200 MPa, a 1% secant modulus, TD (ASTM D882) in a range from about 220 MPa to about 230 MPa, alternatively about 224 MPa, an Elmendorf Tear Strength, MD (ASTM D1922) in a range from about 300 g to about 400 g, alternatively about 325 g, and an Elmendorf Tear Strength, TD (ASTM D1922) in a range from about 600 g to about 700 g, alternatively about 650 g.

Examples of suitable LLDPE that may be used as the virgin polyolefin include, without limitation, LLDPE having the tradename Petrothene®, such as Petrothene® GA601030, Petrothene® GA601031, Petrothene® GA601032, Petrothene® Select GS906061, and Petrothene® Select GS906062, all of which are commercially available from LyondellBasell Industries Holdings, B.V.

### PCR-Polyethylene

The compositions disclosed herein further include at least one PCR polyethylene (PCR-PE) resin. The post-consumer material may be crushed and ground into small particles or flakes that can then be combined with the virgin LLDPE in an extrusion hopper.

Any PCR-PE resin can be used in the present compositions, including all types of PE. In at least one aspect, the PCR-PE resin is a recycled high density or low-density PE. In at least one aspect, the PCR-PE resin is a recycled LLDPE resin. In at least another aspect, the PCR-PE resin is a recycled low-density polyethylene (LDPE)/LLDPE resin.

In at least one aspect, the PCR-PE resin is PCR linear low-density polyethylene (PCR-LLDPE). In one example, the PCR-PE resin is a PCR-LLDPE having a melt index (190° C./2.16 kg) of about 0.9 g/10 min and a density of 0.927 g/cm³. In another example, the PCR-PE resin is a PCR-LLDPE having a melt index (190° C./2.16 kg) of about 4.0 g/10 min and a density of 0.928 g/cm³. In yet another example, the PCR-PE resin is a PCR-LLDPE having a melt index (190° C./2.16 kg) of about 0.25 g/10 min and a density of 0.923 g/cm³. In yet another example, the PCR-PE resin is a PCR-LLDPE having a melt index (190° C./2.16 kg) of about 0.75 g/10 min and a density of 0.923 g/cm³. In yet another example, the PCR-PE resin is a PCR-LLDPE having a melt index (190° C./2.16 kg) of about 4.0 g/10 min and a density of 0.924 g/cm³.

In at least one aspect, the total amount of PCR-PE resin in the present composition is in a range from about 1 wt. % to about 75 wt. % based on the total weight of the composition. In some implementations, the total amount of PCR-PE resin present is in a range from about 5 wt. % to about 75 wt. %, or in a range from about 10 wt. % to about 50 wt. %, or in a range from about 10 wt. % to about 40 wt. %, or in a range from about 20 wt. % to about 40 wt. %, or in a range from about 10 wt. % to about 30 wt. %, or in a range from about 20 wt. % to about 30 wt. %, or in a range from about 25 wt. % to about 35 wt. %, or in a range from about 25 wt. % to about 30 wt. %, or the total amount of PCR-PE resin present is in an amount of 1, 5, 10, 15, 20, 25, 30, 35, 40, 45, 50, 55, 60, 65, 70, or 75 wt. %.

In some implementations, the PCR-PE resin has a melt index (190° C./2.16 kg) in a range from about 0.2 g/10 min to about 5 g/10 min, or in a range from about 0.25 g/10 min to about 4.0 g/10 min, or in a range from about 0.25 g/10 min to about 0.9 g/10 min, or in a range from about 0.25 g/10 min to about 0.75 g/10 min, or in a range from about 0.75 g/10 min to about 0.9 g/10 min, or in a range from about 0.9 g/10 min to about 4.0 g/10 min and a density in a range from about 0.9 to about 0.95 g/cm³, or in a range from about 0.92 to about 0.93 g/cm³, or in a range from about 0.91 to about 0.93 g/cm³, or in a range from about 0.923 to about 0.928 g/cm³, or in a range from about 0.923 to about 0.924 g/cm³, or in a range from about 0.923 to about 0.927 g/cm³, or in a range from about 0.927 to about 0.928 g/cm³. Unless otherwise stated, the foregoing densities are measured according to ISO 1183-1 and the foregoing melt index values are measured according to ISO 1133-1.

In some implementations, the PCR-PE resin is a recycled LLDPE with a melt index in a range from about 0.2 g/10 min to about 5 g/10 min and a density in a range from about 0.9 to about 0.95 g/cm³.

In some implementations, the PCR-PE is a recycled LLDPE with a melt index in a range from about 0.5 g/10 min to about 1.5 g/10 min (ASTM D1238) and a density in a range from about 0.918 to about 0.932 g/cm³ (ASTM D792).

Examples of suitable PCR-PE resin that may be used as the PCR polyethylene include, without limitation, PCR-LDPE having the tradename CirculenRenew™, such as CirculenRenew™ C14 LD2420D, and CirculenRenew™ C14 LD242OF Plus, CirculenRenew™ C14 LD2420K, CirculenRenew™ C14 LD3020F, CirculenRenew™ C14 LD3020K, all of which are commercially available from LyondellBasell Industries Holdings, B.V. Additional examples of suitable PCR-LDPE resin that may be used as the PCR polyethylene are commercially available from Circulus Holdings, PBLLC. Examples of suitable LDPE/LLDPE-PCR are commercially available from Avanguard Innovative of Houston, Texas.

### Optional Additives:

In addition to the virgin resin and the PCR-PE resin, the compositions can include optional additives to impart color, including a dye, pigment, or other substance that imparts color to the polymeric composition and subsequent articles, and includes substances that impart metallic or pearlescent effects.

Further, the compositions can include antioxidants, nucleators, slip agents, UV light stabilizers, anti-scratch agents, processing aids or other additives as needed for the end-use of the composition and/or articles.

The present disclosure further includes aspects for articles and methods of forming the articles.

Some aspects of the present disclosure are directed to an article prepared using any of the above described compositions. Alternatively, the implementations are directed to an article prepared using any of the above compositions, wherein the article is in the form of sheets, films, pipes, strands, tubes, containers, pellets, or custom profiles specific to certain applications.

Some aspects of the present disclosure are methods of producing an article from any of the above-described compositions, the method involving dry-blending the virgin resin(s) and the PCR-PE resin; melting the composition at a known temperature; and extruding the composition through a die. In some methods, the method of dry-blending and melting occur in an extruder hopper. In some implementations, the virgin resin(s) and the PCR-PE are melt blended in a twin screw extruder, and then the pelletized blend is used to blow the film. In some implementations, the processing conditions include a melt temperature of 204° C. to 232° C. and a 1.5-3.01:1 blow-up-ratio, for example, a 2.5:1 blow-up-ratio.

### Physical Properties

The compositions and articles formed therefrom can have the following physical properties.

### Melt Index

In some implementations, the composition has a melt index (ASTM D1238) (190° C./2.16 kg) in a range from about 0.6 to about 1.2 g/10 min, or in a range from about 0.7 to about 1.0 g/10 min, or in a range from about 0.8 to about 1.0 g/10 min. In at least one implementation, the composition has a melt index of 0.6 g/10 min, 0.7 g/10 min, 0.8 g/10 min, 0.9 g/10 min, 1.0 g/10 min, 1.1 g/10 min, or 1.2 g/10 min.

### Density

In some implementations, the composition has a density (ASTM D1505) in a range from about 0.916 to about 0.922 g/cm³, or in a range from about 0.917 to about 0.920 g/cm³, or in a range from about 0.918 to about 0.919 g/cm³. In at least one implementation, the composition has a density of 0.916, 0.917, 0.918, 0.919, 0.920, 0.921 or 0.922 g/cm³.

### Elmendorf Tear Strength (Machine Direction)

In some implementations, the composition has a tear strength (machine direction) (ASTM D1922) in a range from about 100 to about 200 g, or in a range from about 120 to about 180 g, or in a range from about 140 to about 160 g, or in a range from about 150 to about 160 g. In at least one implementation, the composition has a tear strength (machine direction) of 100 g, 110 g, 120 g, 130 g, 140 g, 150 g, 160 g, 170 g, 180 g, 190 g, or 200 g.

### Elmendorf Tear Strength (Transverse Direction)

In some implementations, the composition has a tear strength (transverse direction) (ASTM D1922) in a range from about 700 to about 800 g, or in a range from about 720 to about 780 g, or in a range from about 740 to about 760 g, or in a range from about 750 to about 760 g. In at least one implementation, the composition has a tear strength (transverse direction) of 700 g, 710 g, 720 g, 730 g, 740 g, 750 g, 760 g, 770 g, 780 g, 790 g, or 800 g.

### Dart Drop Impact Strength

In some implementations, the composition has a dart drop impact strength (ASTM D1709) in a range from about 50 to about 150 g, or in a range from about 80 to about 120 g, or in a range from about 90 to about 110 g, or in a range from about 100 to about 110 g. In at least one implementation, the composition has a dart drop impact strength of 50 g, 60 g, 70 g, 80 g, 90 g, 100 g, 110 g, 120 g, 130 g, 140 g, or 150 g.

### Total Energy Dart Drop

In some implementations, the composition has a total energy dart drop in a range from about 1.0 to about 1.5 ft-lbs, or in a range from about 1.1 to about 1.4 ft-lbs, or in a range from about 1.25 to about 1.3 ft-lbs. In at least one implementation, the composition has a total energy dart drop of 1.0 ft-lbs., 1.1 ft-lbs., 1.2 ft-lbs., 1.3 ft-lbs., 1.4 ft-lbs., or 1.5 ft-lbs.

### Tensile Strength at Break (Machine Direction)

In some implementations, the composition has a tensile strength at break (machine direction) (ASTM D882) in a range from about 6,000 psi to about 7,000 psi, or in a range from about 6,200 to about 6,500 psi, or in a range from about 6,300 to about 6,400 psi. In at least one implementation, the composition has a total energy dart drop of 6,000 psi, 6,100 psi, 6,200 psi, 6,300 psi, 6,400 psi, 6,500 psi, 6,600 psi, 6,700 psi, 6,800 psi, 6,900 psi, or 7,000 psi.

### Tensile Strength at Break (Transverse Direction)

In some implementations, the composition has a tensile strength at break (transverse direction) (ASTM D882) in a range from about 5,000 to about 5,700 psi, or in a range from about 5,100 to about 5,400 psi, or in a range from about 5,200 to about 5,300 psi. In at least one implementation, the composition has a tensile strength at break (transverse direction) of 5,000 psi, 5,100 psi, 5,200 psi, 5,300 psi, 5,400 psi, 5,500 psi, 5,600 psi, or 5,700 psi.

### Tensile Modulus

In some implementations, the composition has a tensile modulus (machine direction) in a range from about 30,000 to about 40,000 psi, or in a range from about 34,000 to about 38,000 psi, or in a range from about 35,000 to about 36,000 psi. In at least one implementation, the composition has a tensile modulus (machine direction) of 30,000 psi, 31,000 psi, 32,000 psi, 33,000 psi, 34,000 psi, 35,000 psi, 36,000 psi, 37,000 psi, 38,000 psi, 39,000 psi, or 40,000 psi.

In some implementations, the composition has a tensile modulus (transverse direction) in a range from about 40,000 to about 50,000 psi, or in a range from about 44,000 to about 48,000 psi, or in a range from about 45,000 to about 46,000 psi. In at least one implementation, the composition has a tensile modulus (transverse direction) of 40,000 psi, 41,000 psi, 42,000 psi, 43,000 psi, 44,000 psi, 45,000 psi, 46,000 psi, 47,000 psi, 48,000 psi, 49,000 psi, or 50,000 psi.

### B. Multi-Layer Film Structure

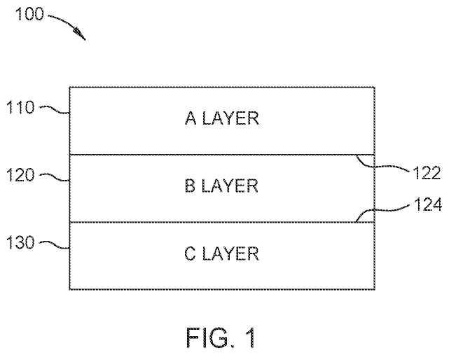

Aspects of the disclosed subject matter are also directed to film structures including at least the three layers described generally as an A Layer that is an outer skin layer, a B Layer that is a core layer, and a C Layer that is an inner skin or sealant layer. The C Layer is adjacent a first side of the B Layer, and the A Layer is adjacent a second side of the B Layer. For example, FIG. 1 illustrates a representative multi-layer film structure 100, for example, A/B/C film structure including a B Layer 120 positioned between an A Layer 110 and a C Layer 130.

In some aspects, the multi-layer film structure 100 can have the three layers as described above, while in other aspects, the multi-layer film structure 100 can have four or more layers. Thus, the B Layer 120 is not limited only to a middle layer in between the A Layer 110 and the C Layer 130, thus, other layers can be present. The A Layer 110 and the C Layer 130 are described as being positioned on a first side 122 and a second side 124, respectively, of the B Layer 120. An additional layer, or layers, can be between the B Layer 120 and the A Layer 110, and likewise, between the B Layer 120 and the C Layer 130.

In at least one aspect, the A Layer 110 is present in an amount ranging from 15 to 25 wt. %, or in an amount ranging from 20 to 25 wt. % based on the total weight of the multi-layer film structure 100. The A Layer 110 may be present in an amount of 20 wt. % based on the total weight of the multi-layer film structure 100.

In at least one aspect, the B Layer 120 is present in an amount ranging from 50 to 70 wt. %, or in an amount ranging from 60 to 70 wt. % based on the total weight of the multi-layer film structure 100. The B Layer 120 may be present in an amount of 60 wt. % based on the total weight of the multi-layer film structure 100.

In at least one aspect, the C Layer 130 is present in an amount ranging from 15 to 25 wt. %, or in an amount ranging from 20 to 25 wt. % based on the total weight of the multi-layer film structure 100. The C Layer 130 may be present in an amount of 20 wt. % based on the total weight of the multi-layer film structure 100.

In at least one aspect, the multi-layer film structure has a gloss ranging from 50% to 55%. The multi-layer film structure may have a gloss ranging from 53% to 55%. The multi-layer film structure may have a gloss of 53%, 54%, or 55%. The foregoing gloss is measured according to ASTM D 2457.

In at least one aspect, the multi-layer film structure has a haze ranging from 15% to 20%. The multi-layer film structure may have a haze ranging from 15% to 17%. The multi-layer film structure may have a haze of 15%, 16%, or 17%. The foregoing haze is measured according to ASTM D 1003.

In at least one aspect, the multi-layer film structure has a narrow angle scattering (NAS) ranging from 15% to 20%. The multi-layer film structure may have a NAS ranging from 17% to 19%. The multi-layer film structure may have a NAS of 17%, 18%, or 19%. The foregoing NAS is measured according to ASTM D1746.

In at least one aspect, the multi-layer film structure has a machine direction tear strength ranging from 50 to 150 g. The multi-layer film structure may have a machine direction tear strength ranging 50 to 110 g. The multi-layer film structure may have a machine direction tear strength of 50, 59, or 107 g. The foregoing machine direction tear strength is measured according to ASTM D 1922.

In at least one aspect, the multi-layer film structure has a transverse direction tear strength ranging from 300 to 400 g. The multi-layer film structure may have a transverse direction tear strength ranging from 320 to 370 g. The multi-layer film structure may have a transverse direction tear strength of 332, 352, or 363 g. The foregoing transverse direction tear strength is measured according to ASTM D 1922.

In at least one aspect, the multi-layer film structure has a machine direction break strength ranging from 5,000 to 11,000 g. The multi-layer film structure may have a machine direction break strength ranging 5,540 to 9,110 g. The multi-layer film structure may have a machine direction break strength of 5540, 6340, or 9,110 g. The foregoing machine direction break strength is measured according to ASTM D882.

In at least one aspect, the multi-layer film structure has a transverse direction break strength ranging from 2,500 to 4,000 g. The multi-layer film structure may have a transverse direction break strength ranging from 2860 to 3900 g. The multi-layer film structure may have a transverse direction break strength of 2860, 3720, or 3900 g. The foregoing transverse direction tear strength is measured according to ASTM D882.

In at least one aspect, the multi-layer film structure has an average puncture energy ranging from 0.9 Joules to 1.2 Joules. The multi-layer film structure may have an average puncture energy ranging from 0.91 Joules to 1.12 Joules. The multi-layer film structure may have an average puncture energy of 0.91, 1.08, or 1.12 Joules.

In at least one aspect, the multi-layer film structure has a total energy dart drop ranging from 0.3 Joules to 0.6 Joules. The multi-layer film structure may have a total energy dart drop ranging from 0.35 Joules to 0.5 Joules. The multi-layer film structure may have a total energy dart drop of 0.35, 0.41, or 0.51 Joules.

### A Layer & C Layer

In at least one aspect, the A Layer 110 and C Layer 130 each independently comprise a polyethylene, for example, a high-density polyethylene (HDPE), LLDPE, or a blend of HDPE and LLDPE and optionally a nucleating agent.

In at least one aspect, the HDPE has a melt index ranging from 0.4 to 2.5 g/10 min, as measured according to ASTM D 1238. The HPDE may have a melt index of 2.0 g/10 min, as measured according to ASTM D 1238.

In at least one aspect, the HDPE has a density ranging from 0.940 to 0.970 g/cm³, as measured according to ASTM D 1505. The HDPE may have a density of 0.959 g/cm³, as measured according to ASTM D 1505.

In at least one aspect, the HDPE has a polydispersity index ranging from 1.8 to 18.0, as measured by ASTM D 6474-12.

Suitable examples of HDPE, without limitation, include Alathon® M6020SB HDPE, Alathon® L5485 HDPE, Alathon® L5885 HDPE and Alathon® M6210 HDPE, all of which are commercially available from LyondellBasell industries Holdings, B.V.

In at least one aspect, the LLDPE has a melt index ranging from 0.4 to 2.5 g/10 min. In another aspect, the LLDPE of has a melt index ranging from 0.6 to 1.0 g/10 min. In yet another aspect, the LLDPE has a melt index of 0.6, 0.75, or 1.0 g/10 min. In each of the foregoing aspects, the melt index is measured according to ASTM D 1238.

In at least one aspect, the LLDPE has a density ranging from 0.910 to 0.922 g/cm³. In another aspect, the LLDPE has a density ranging from 0.916 to 0.920 g/cm³. In yet another aspect, the LLDPE has a density of 0.916, 0.918, or 0.920 g/cm³. The foregoing densities are measured according to ASTM D 1505.

In at least one aspect, the LLDPE has a polydispersity index ranging from 2.0 to 16.0, as measured by ASTM D 6474-12. In another aspect, the LLDPE has a polydispersity index ranging from 5.0 to 16.0. In each of the foregoing aspects, the polydispersity index is measured according to ASTM D 6474-12.

In at least one aspect, the LLDPE includes ethylene derived units copolymerized with a comonomer selected from the group consisting of 1-butene, 1-hexene, 1-octene, and any combination of two or more of the foregoing. The LLDPE of the may include a metallocene-derived LLDPE, a Ziegler-Natta-derived LLDPE, and/or any LLDPE derived from any other catalyst known in the art. In another aspect, the comonomer is present in an amount ranging from 4 to 30 wt. %, based upon the total weight of the LLDPE.

Examples of suitable LLDPE that may comprise the A Layer include, without limitation, LLDPE having the tradenames Petrothene® GA501 series of resins, Petrothene® GA501023, Petrothene® GA502023, Petrothene® GA601030, Petrothene® GA601031, Petrothene® GA601032, Petrothene® Select GS906061, Petrothene® Select GS906062, and Petrothene® GA808091, all of which are commercially available from LyondellBasell Industries Holdings, B.V.

In at least one aspect, the nucleating agent is present in an amount ranging from 0.05 wt. % to 0.30 wt. % (500 to 3000 ppm), based on the total weight of the A Layer 110 or the C Layer 130. In at least one aspect, the LLDPE and the nucleating agent may be blended together to form a nucleated LLDPE.

The nucleating agent may be an organic nucleating agent. For example, the organic nucleating agent may comprise one or more of metal carboxylates, metal aromatic carboxylate, hexahydrophthalic acid metal salts, stearates, organic phosphates, bisamides, sorbitols, and mixtures thereof. Suitable commercial examples of nucleating agents may include, without limitation, one or more of Hyperform® HPN-20E (which is a mixture of zinc stearate and a calcium salt of 1,2-cyclohexanedicarboxylic acid) or Hyperform® HPN-210M (which is a mixture of zinc stearate and sodium; 4-[(4-chlorobenzoyl)amino]benzoate), both of which are commercially available from Milliken & Company.

In at least one aspect, the LLDPE may comprise a blend of two or more types of polyolefins. For example, the LLDPE may be a blend of LLDPE and one or more high density polyethylenes (HDPEs). Thus, in some aspects, the A Layer 110 and C Layer 130 may independently comprise (a) one or more LLDPEs present in an amount ranging from 40 to 100 wt. %, based upon the total weight of the A Layer 110 or the C Layer 130; (b) one or more HDPEs present in an amount ranging from 0 to 50 wt. %, based upon the total weight of the A Layer 110 or the C Layer 130; and (c) a nucleating agent in an amount ranging from 0.05 wt. % to 0.30 wt. % (500 to 3000 ppm, on a weight basis), based on the total weight of the A Layer 110 or the C Layer 130. In other aspects, the A Layer 110 or the C Layer 130 may comprise a blend of LLDPE and one selected from the group consisting of HDPE, LLDPE, LDPE, and any blend or combination thereof.

In at least one aspect, the A Layer 110 or the C Layer 130 may independently comprise a blend of two or more polyolefins. For example, the A Layer 110 or the C Layer 130 may comprise a blend comprising (a) HDPE homopolymer or a HDPE copolymer in an amount ranging from 40 to 100 wt. %, based on the total weight of the A Layer 110 or the C Layer 130, (b) LLDPE in an amount ranging from 0 to 50 wt. %, based on the total weight of the A Layer 110, and (c) a nucleating agent in an amount up to 0.30 wt. % (up to 3000 ppm), based on the total weight of the A Layer 110 or the C Layer 130. In other aspects, the A Layer 110 or the C Layer 130 may comprise a blend of HDPE (or nucleated HDPE) and one selected from the group consisting of HDPE, LLDPE, LDPE, and any blend or combination thereof.

### The B Layer

The B Layer 120 comprises the PCR-PE composition described. The B Layer 120 may further comprise HDPE, LLDPE, LDPE, and any blend or combination thereof. In at least one aspect, the B Layer 120 comprises a blend of the PCR-PE composition (or nucleated PCR-PE composition) and one selected from the group consisting of HDPE, LLDPE, LDPE, and any blend or combination thereof.

### Additional Layers

In at least one aspect, the multi-layer film structure 100 can have four or more layers, that is, one or more additional layers in addition to the A Layer 110, the B Layer 120, and the C Layer 130. Thus, the B Layer 120 is not limited only to a middle layer in between the A Layer 110 and the C Layer 130, that is, other layers can be present. The A Layer 110 and the C Layer 130 are described as being positioned on the first side 122 and the second side 124, respectively, of the B Layer 120. An additional layer, or layers, can be between the B Layer 120 and the A Layer 110, and likewise, between the B Layer 120 and the C Layer 130.

The one or more additional layers may comprise one or more polymers. For example, in at least one aspect, the one or more additional layers may comprise any of the polymers discussed herein as being polymer options for the A Layer 110, the B Layer 120, and/or the C Layer 130: for example, LLDPE, HDPE, LDPE, or any blend or combination thereof. Additional polymers that can be employed either singly or in combination in the one or more additional layers can include, but are not limited to, ethylene vinyl alcohol (EVOH), tie-layers, Nylon or other polyamides, or combinations thereof. Non-limiting examples of EVOH include resins such as Kuraray Eval™ F171B, Kuraray Eval™ J171B, and Kuraray Eval™ E171B, all of which are commercially available from Kuraray America, Inc. Non-limiting examples of tie-layers include Equistar Plexar® PX3060, Equistar Plexar® PX3227, and Equistar Plexar® PX3236, all of which are commercially available from LyondellBasell. Non-limiting examples of Nylon include UBE Industries 5033 and UBE industries 5034, which are commercially available from Ube Industries, Ltd., as well as AdvanSix Aegis® BarrierPro2™, which is commercially available from AdvanSix Inc.

### EXAMPLES

The following non-limiting examples are provided to further illustrate aspects described herein. However, the examples are not intended to be all inclusive and are not intended to limit the scope of the aspects described herein.

Raw materials used herein include, but are not limited to:
A pelletized Butene LLDPE
A pelletized Hexene LLDPE
A high performance pelletized Hexene LLDPE
CIRCA T™ LDPE/LLDPE PCR
NaturaPCR LDPE/LLDPE PCR

Example 1 and Example 2 were blown on a single layer film extruder with a 4 inch die.

Example 1 (E01) is a blown film having 30 wt. % PCR content produced from a blend of 70 wt. % of the high performance hexene LLDPE and 30 wt. % PCR content.

Example 2 (E02) is a blown film having 30 wt. % PCR content produced from a blend of 70 wt. % hexene LLDPE and 30 wt. % PCR content.

Comparative Example (C01) is a blown film produced from the pelletized Butene LLDPE.

Comparative Example (C02) is a blown film produced from the pelletized Hexene LLDPE.

Comparative Example (C03) is a commercially available bag having a thickness of 0.9 mil and a recycled content of 50%.

Comparative Example (C04) is a commercially available bag having a thickness of 1.0 mil and a recycled content of 20%.

Comparative Example (C05) is a commercially available bag having a thickness of 0.85 mil and a recycled content of 70%.

Comparative Example (C06) is a commercially available bag having a thickness of 0.9 mil and a recycled content of 65%.

Physical properties of inventive examples E01-E02 and comparative examples C01-C06 are summarized in Table I.

TABLE I

| Property | Units | ASTM | E01 | C01 | C02 | E02 | C03 | C04 | C05 | C06 |
|---|---|---|---|---|---|---|---|---|---|---|
| 1% Secant Modulus (MD) | psi | D882 | 25300 | 27000 | 29000 | 36400 | 34000 | 54100 | 38400 | 28000 |
| 1% Secant Modulus (TD) | psi | D882 | 30500 | 28000 | 32500 | 45300 | 38000 | 65700 | 40800 | 7330 |
| Tear Strength (MD) | g | D882 | 280.1 | 125 | 325 | 139.9 | 98 | 76.6 | 189.6 | 224.6 |
| Tear Strength (TD) | g | D882 | 618.3 | 330 | 650 | 721.5 | 842.7 | 862.7 | 689.2 | 536.2 |
| Energy | J | | 1.87 | | | 1.19 | | | | |
| Dart Drop Impact Strength, F50 | g | D1709 | 249 | 100 | 190 | 101 | 139 | 49 | 151 | 147 |
| Impact Flat | ft-lb | | 1.88 | 1.41 | 1.95 | 1.28 | 1.91 | 0.95 | 1.34 | 1.61 |
| Average ness | mils | | 1.11 | 0.5 | 0.5 | 0.87 | 0.95 | 1.12 | 0.63 | 0.9 |
| Tensile Strength at Break (MD) | psi | D882 | 5170 | 6600 | 8100 | 6310 | 7660 | 5470 | 7700 | 4650 |
| Tensile Elongation at Break (MD) | % | D882 | 500 | | | 500 | 410 | 420 | 540 | 450 |
| Tensile Strength at Break (TD) | Psi | D882 | 4580 | 4700 | 6100 | 5220 | 4740 | 4450 | 5440 | 3840 |
| Tensile Elongation at Break (TD) | % | D882 | 690 | | | 730 | 690 | 650 | 700 | 520 |

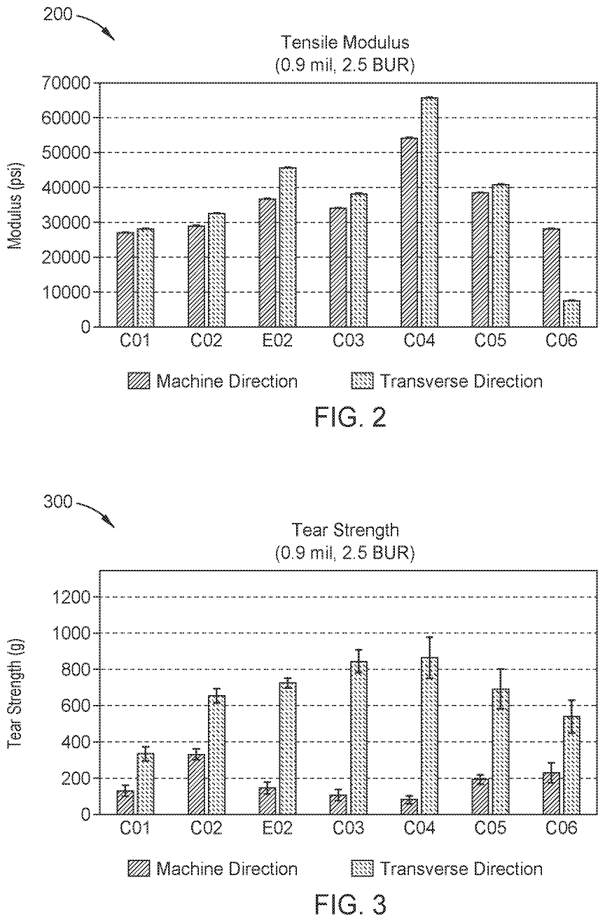

FIG. 2 is a bar graph 200 illustrating the results of a tensile modulus test performed for the compositions presented in the examples section of the present application. As depicted in bar graph 200, E02 has similar tensile modulus to C01 and C03-C06.

FIG. 3 is a bar graph 300 illustrating the results of a tear strength test performed for the compositions presented in the examples section of the present application. As depicted in bar graph 300, E02 has similar tensile strength to C01-C06.

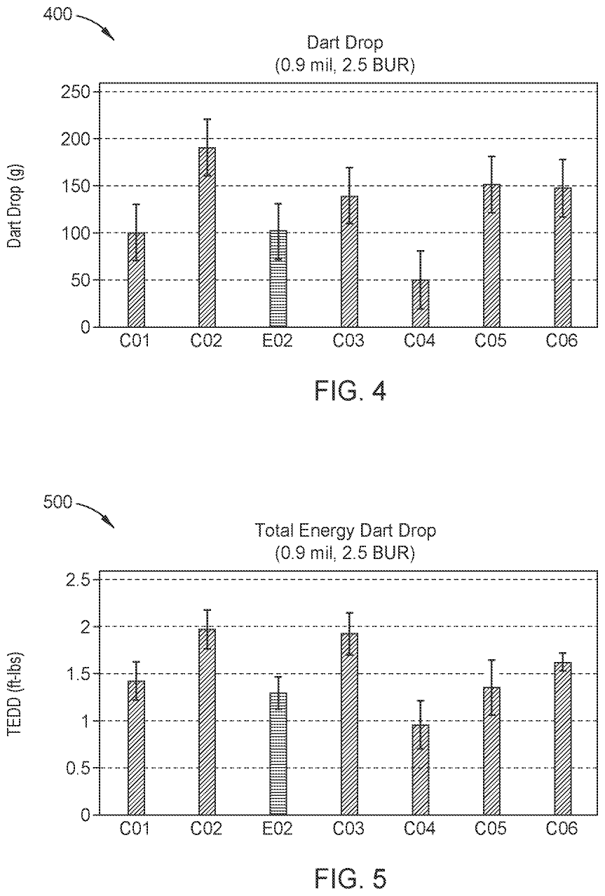

FIG. 4 is a bar graph 400 illustrating the results of a dart drop test performed for the compositions presented in the examples section of the present application. As depicted in bar graph 400, E02 has similar tensile strength to C01-C06.

FIG. 5 is a bar graph 500 illustrating the results of a total energy dart drop test performed for the compositions presented in the examples section of the present application. As depicted in bar graph 500, E02 has similar total energy dart drop test to C01-C06.

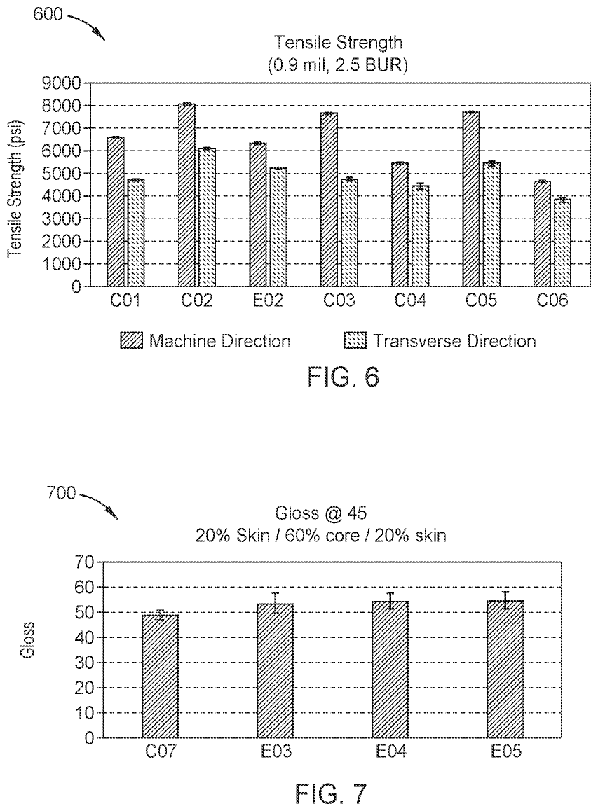

FIG. 6 is a bar graph 600 illustrating the results of a tensile strength test performed for the compositions presented in the examples section of the present application. As depicted in bar graph 500, E02 has similar tensile strength to C01-C06.

The non-limiting examples E01 and E02 show that the blown films formed from inventive examples E01 and E02, demonstrate properties similar to those of virgin resins and commercially available bags with comparable PCR content.

Compositions of inventive multi-layer film examples E03-E05 and comparative example C07 are summarized in Table II. Properties of inventive examples E03-E05 and comparative examples C07 are summarized in Table III.

TABLE II

| | 40% Skins | | 60% Core | | | |
|---|---|---|---|---|---|---|
| | Skin | Skin | Core | Core | | |
| | Material | Material | Material | Material | PCR- | PCR in |
| | 1 | 2 | 1 | 2 | PE | Film |
| C07 | 80% | 20% | 70% | 30% | 0% | 0% |
| E03 | 80% | 20% | 20% | 30% | 50% | 9% |
| E04 | 80% | 20% | 0% | 25% | 75% | 13.5% |
| E05 | 80% | 20% | 0% | 0% | 100% | 18% |

In Table III, the results for certain properties of the multi-layer film structures of the Examples are presented.

TABLE III

| | Units | C07 | E03 | E04 | E05 |
|---|---|---|---|---|---|
| Gloss @ 45° | % | 48.7 | 53.4 | 54.2 | 54.5 |
| Haze | % | 17.7 | 15.1 | 15.4 | 16.5 |
| Narrow Angle | | 18.9 | 19 | 18.8 | 18.5 |
| Scattering | | | | | |
| Tear Strength | g | 167.5 | 106.7 | 58.9 | 50.2 |
| (MD) | | | | | |
| Tear Strength | g | 346.4 | 363.6 | 332.6 | 352.5 |
| (TD) | | | | | |
| Break | psi | 10100 | 9110 | 5540 | 6340 |
| Strength | | | | | |
| (MD) | | | | | |
| Break | psi | 3420 | 3900 | 3720 | 2860 |
| Strength (TD) | | | | | |
| Puncture | J | 1.18 | 1.08 | 1.12 | 0.91 |
| Total Energy | J | 0.39 | 0.35 | 0.51 | 0.41 |
| Dart Drop | | | | | |

FIG. 7 is a bar graph 700 illustrating the results of a gloss test performed for the multi-layer film structures presented in Table II and Table III of the present application. Gloss is believed to be primarily a function of skin layers. Although the average gloss for E03-E05 appears to increase relative to C07, all values are close to within on standard deviation of each other, thus no significant differences are noted between C07 and E03-E05.

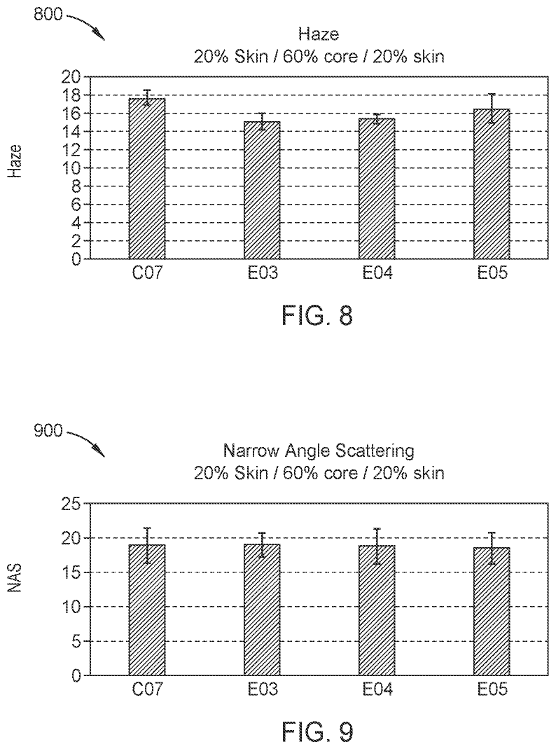

FIG. 8 is a bar graph 800 illustrating the results of a haze test performed for the multi-layer film structures presented in Table II and Table III of the present application. Although the average haze for E03-E05 is lower than C07, the values are close to within one standard deviation.

FIG. 9 is a bar graph 900 illustrating the results of a narrow angle scattering test performed for the multi-layer film structures presented in Table II and Table III of the present application. The narrow angle scattering values for E03-E05 are all close to C07 indicating no significant difference in narrow angle scattering.

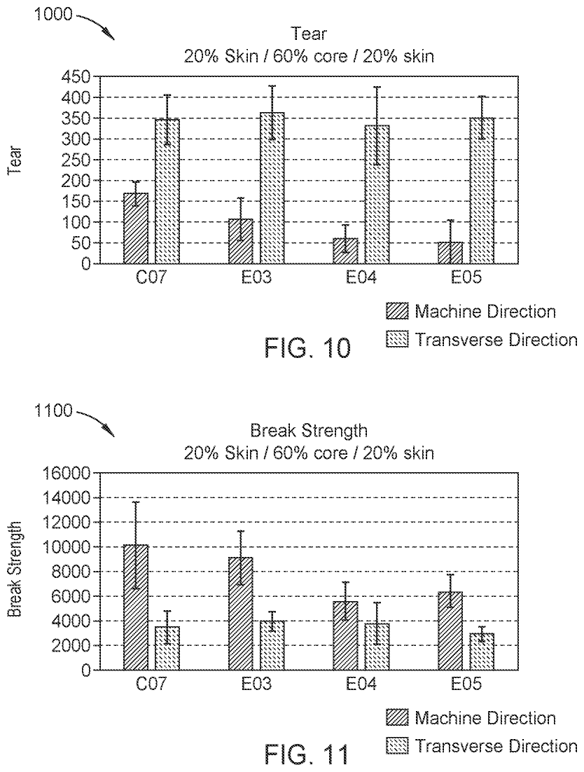

FIG. 10 is a bar graph 1000 illustrating the results of a tear strength test performed for the multi-layer film structures presented in Table II and Table III of the present application. The average machine direction tear strength of the multi-layer films decreased as PCR content increased for C07 and E03-E05. Although the error bars are relatively large for tear testing, there does appear to be an inverse relationship between MD tear strength and PCR content. The transverse direction tear strength did not vary inversely with PCR content.

FIG. 11 is a bar graph 1100 illustrating the results of a break strength test performed for the multi-layer film structures presented in Table II and Table III of the present application. Similar to the tear strength data depicted in the bar graph 1000, the average break strength in the machine direction also appears to drop off as PCR content increases, however, the large variation within the measurements challenges the significance of the differences. No such trend is visible in the transverse direction.

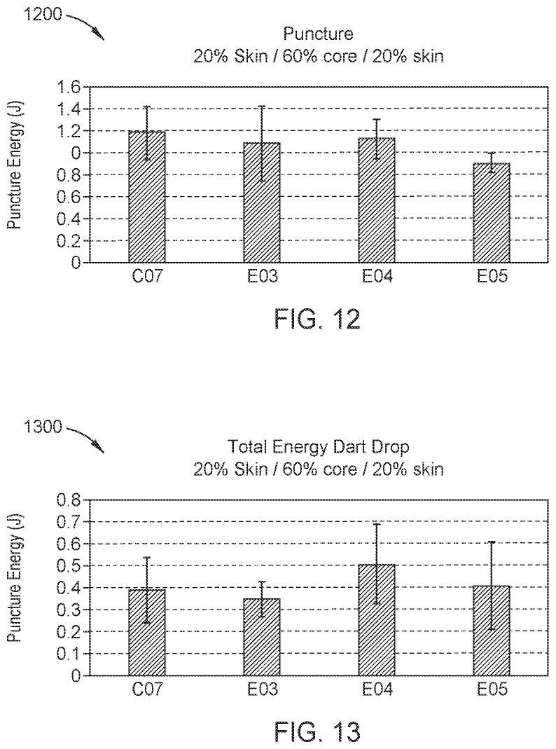

FIG. 12 is a bar graph 1200 illustrating the results of a puncture test performed for the multi-layer film structures presented in Table II and Table III of the present application. As with other data, the average puncture energy decreases as PCR content increases but the high standard deviation makes the change statistically insignificant.

FIG. 13 is a bar graph 1300 illustrating the results of a total energy dart drop test performed for the multi-layer film structures presented in Table II and Table III of the present application. The total energy dart drop showed no significant changes between C07 and E03-E05.

In the Summary, the Detailed Description, the Claims, and in the accompanying drawings, reference is made to particular features (including method operations) of the present disclosure. It is to be understood that the disclosure in this specification includes all possible combinations of such particular features. For example, where a particular feature is disclosed in the context of a particular aspect or implementation of the present disclosure, or a particular claim, that feature can also be used, to the extent possible in combination with and/or in the context of other particular aspects and implementations of the present disclosure, and in the present disclosure generally.

All documents described herein are incorporated by reference herein, including any priority documents and/or testing procedures to the extent they are not inconsistent with this text. As is apparent from the foregoing general description and the specific aspects, while forms of this disclosure have been illustrated and described, various modifications can be made without departing from the spirit and scope of this disclosure. Accordingly, it is not intended that this disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

As used herein, “post-consumer waste” refers to a type of waste produced by the end consumer of a material stream. The term “recycle” means processing an item into new raw materials. When post-consumer waste is processed into raw materials, as opposed to disposal as solid waste, the raw material is called “post-consumer recycled” material. In the presently disclosed compositions and methods, the term “post-consumer resins” refer to post-consumer recycled material that is a polymer resin. The terms “virgin” and “virgin resins” refer to resins that have not yet been processed into a consumer item.

While the foregoing is directed to aspects of the present disclosure, other and further aspects of the disclosure may be devised without departing from the basic scope thereof, and the scope thereof is determined by the claims that follow.

1. A composition, comprising:
a virgin linear low-density polyethylene (LLDPE) resin present in an amount ranging from about 25 wt. % to about 99 wt. % based on a total weight of the composition; and
a post-consumer recycled polyethylene (PCR-PE) resin present in an amount ranging from about 1 wt. % to about 75 wt. % based on a total weight of the composition.

2. The composition of claim 1, wherein the virgin LLDPE has a density ranging from 0.910 to 0.922 g/cm³.

3. The composition of claim 1, wherein the virgin LLDPE is hexene LLDPE.

4. The composition of claim 3, wherein the virgin LLDPE resin has a melt flow ratio greater than or equal to 0.6 g/10 min (190° C./2.16 kg).

5. The composition of claim 4, wherein the virgin LLDPE resin has a dart drop impact strength, F50 (ASTM D1709) in a range from about 600 g to about 700 g and a tensile strength at break, MD (ASTM D882) in a range from about 60 MPa to about 70 MPa.

6. The composition of claim 1, wherein the virgin LLDPE has a melt flow ratio greater than or equal to 1.0 g/10 min (190° C./2.16 kg).

7. The composition of claim 6, wherein the virgin LLDPE has a dart drop impact strength, F50 (ASTM D1709) in a range from about 150 g to about 200 g and a tensile strength at break, MD (ASTM D882) in a range from about 50 MPa to about 60 MPa.

8. The composition of claim 1, wherein the PCR-PE resin is present in an amount ranging from about 10 wt. % to about 50 wt. % based on a total weight of the composition and the virgin LLDPE resin is present in an amount ranging from about 50 wt. % to about 90 wt. % based on a total weight of the composition.

9. The composition of claim 1, wherein the PCR-PE resin is present in an amount ranging from about 20 wt. % to about 30 wt. % based on a total weight of the composition.

10. The composition of claim 9, wherein the virgin LLDPE resin is present in an amount ranging from about 70 wt. % to about 80 wt. % based on a total weight of the composition.

11. An article formed from the composition of claim 1.

12. The article of claim 11, wherein the article is in the form of sheets, films, pipes, strands, tubes, containers, or pellets.

13. The article of claim 11, wherein the article is a blown film.

14. A film structure, comprising:
(A) an A Layer, comprising linear low-density polyethylene (LLDPE) or high-density polyethylene (HDPE);
(B) a B Layer, comprising:
a virgin linear low-density polyethylene (virgin LLDPE); and
a post-consumer recycled polyethylene (PCR-PE) resin present in an amount ranging from about 1 wt. % to about 75 wt. % based on a total weight of the virgin LLDPE and the PCR-PE and the virgin LLDPE resin is present in an amount ranging from about 25 wt. % to about 99 wt. % based on a total weight of the virgin LLDPE and the PCR-PE; and
(C) a C Layer, comprising LLDPE or HDPE, wherein the B Layer is positioned between the A Layer and the C Layer.

15. The film structure of claim 14, wherein the B Layer further comprises a core material selected from LLDPE, low-density polyethylene (LDPE), or blends thereof.

16. The film structure of claim 14, wherein the B Layer is present in an amount ranging from about 50 wt. % to about 70 wt. % based on a total weight of the film structure.

17. The film structure of claim 16, wherein the A Layer is present in an amount ranging from about 15 wt. % to about 25 wt. % based on a total weight of the film structure.

18. The film structure of claim 17, wherein the C Layer present in an amount ranging from about 15 wt. % to about 25 wt. % based on a total weight of the film structure.

19. The film structure of claim 14, wherein the PCR-PE resin is present in an amount ranging from about 10 wt. % to about 50 wt. % and the virgin LLDPE resin is present in an amount ranging from about 50 wt. % to about 90 wt. % based on a total weight of the virgin LLDPE and the PCR-PE.
